(19) United States
(12) Patent Application Publication
(10) Pub. No.: US 2004/0155111 A1
(43) Pub. Date: Aug. 12, 2004

(54) Golf data entry card, gold scoring system and a method of golf scoring

(76) Inventors: Clive S Truman, Wellington (NZ); Kelosoma F Siolo, Wellington (NZ)

Correspondence Address: NIXON & VANDERHYE, PC, 1100 N GLEBE ROAD, 8TH FLOOR, ARLINGTON, VA, 22201-4714, US

(21) Appl. No.: 10/478,312

(22) PCT Filed: May 8, 2002
(86) PCT No.: PCT/NZ02/00089

(30) Foreign Application Priority Data
May 22, 2001 (NZ) 511865
Aug. 16, 2001 (NZ) 513607

(51) Int. Cl. G06K 7/10; G06K 19/06

(52) U.S. Cl. 235/470; 235/494

(57) ABSTRACT

A golf data entry card includes a first printed region for entering a member identification code and a second printed region for entering the number of strokes played for each hole. The card is designed to be read by an optical mark reader so that the information may be processed by a processor. Processor may be connected to a central processor which may receive data and perform processing. A golf statistics data entry card includes a first printed region for entering a member identification code and a second printed region for entering player statistical information. Golf statistical information may be generated based upon the player statistical information alone or in combination with historical player statistical information.

### FIELD OF THE INVENTION

The present invention relates to a golf data entry card, a method of golf scoring and a system for recording golf scores.

### BACKGROUND OF THE INVENTION

Conventional golf scoring cards have required players to record their names, scores for each hole and other relevant data, such as the date and tees played off. Where conventional golf scoring cards are used for handicapping or to determine the result of a tournament a person has transcribed the data for manual calculation or entered it into a computer for processing. This approach is prone to human error, labour intensive, costly and results in annoying delays where the results of tournaments are awaited.

A number of patents disclose methods for inputting players' scores on machine readable cards to enable automated reading and processing of golf scores. U.S. Pat. No. 5,314,208, GB 2227417 and DE 3237586 disclose methods using punch cards to record scores. WO 98/44998 and AU 666638 disclose a method wherein a personalised scoring card is printed upon entry of player information. This requires a relatively high quality printer to be provided at each golf course and can result in delays where a number players wish to obtain cards simultaneously. WO 00/09220 discloses a golf score card including a field for recording golf scores and player handicap.

None of the above patents disclose a golf data entry card in which a player identification code can be entered in machine readable form on the data entry card.

### DISCLOSURE OF THE INVENTION

It is an object of the present invention to provide a data entry card enabling player identification to be input in machine readable form and a method and system therefor or to at least provide the public with a useful choice.

According to a first aspect of the invention there is provided a golf data entry card including:

a first printed region including a plurality of sub-regions in a predetermined configuration suitable for reading by an optical mark reader having indicia printed therein for entering a member identification code; and

a second printed region including a plurality of sub-regions in a predetermined configuration suitable for reading by an optical mark reader having indicia for entering the number of strokes for each hole played.

The indicia for identifying a member identification code preferably consists of a series of boxes containing the numerals 0 to 9. The member identification code is preferably in the form of a first series of boxes for entry of the club ID and a second series of boxes for entering the player ID. The card preferably includes further regions for entry of the date and the tees played off.

According to a further aspect of the invention there is provided a method of recording golf scoring information including the steps of:

i) providing a card as hereinbefore defined

ii) marking sub-regions of the first region to enter a member identification code;

iii) marking sub-regions of the second region to enter the number of strokes for the holes played;

iv) reading the card by an optical mark reader and providing the information to a processor; and

v) processing the information to generate scoring information for the player.

The processing means may be connected to a network enabling transfer of scoring information to a central processor. Either the local processing means or the central processing means may calculate the players handicap based on current and historical scoring information. Either the local processing means or central processing means may calculate tournament results.

There is further provided a system for processing golf data entry cards including:

i) an optical mark reader suitable for reading a golf data entry card of the type hereinbefore defined;

ii) a processing means having a data connection to the optical mark reader programmed to extract information from the data entry card hereinbefore defined.

According to a further aspect of the invention there is provided a golf statistics data entry card including:

a first printed region including a plurality of sub regions in a predetermined configuration suitable for reading by an optical mark reader having indicia printed therein for entering a member identification code; and

a second printed region including a plurality of sub regions in a predetermined configuration suitable for reading by an optical mark reader having indicia for entering player statistical information printed in the sub regions.

The player's statistics may include:

i) the number of putts for each hole;

ii) the number of putts for a round;

iii) the direction of each drive

iv) the position of each approach shot with respect to the green.

v) stroke saving shots played on any hole.

According to a further aspect of the invention there is provided a method of obtaining golf statistics information including the steps of:

i) providing a card as hereinbefore defined;

ii) marking sub regions of the first region to enter a member identification code;

iii) marking sub regions of the second region to enter player statistical information;

iv) reading the card by an optical mark reader and providing information to a processor; and

v) processing the information to generate golf statistical information for the player.

### BRIEF DESCRIPTION OF THE DRAWINGS

The invention will now be described by way of example with reference to the accompanying drawings in which:

FIG. 1: shows a golf data entry card.

FIG. 2: shows a system for reading and processing information obtained from the data entry card shown in FIG. 1.

FIG. 3: shows a golf data entry card according to a second embodiment.

FIG. 4 shows a golf statistics data card.

### DETAILED DESCRIPTION OF THE PREFERRED EMBODIMENT

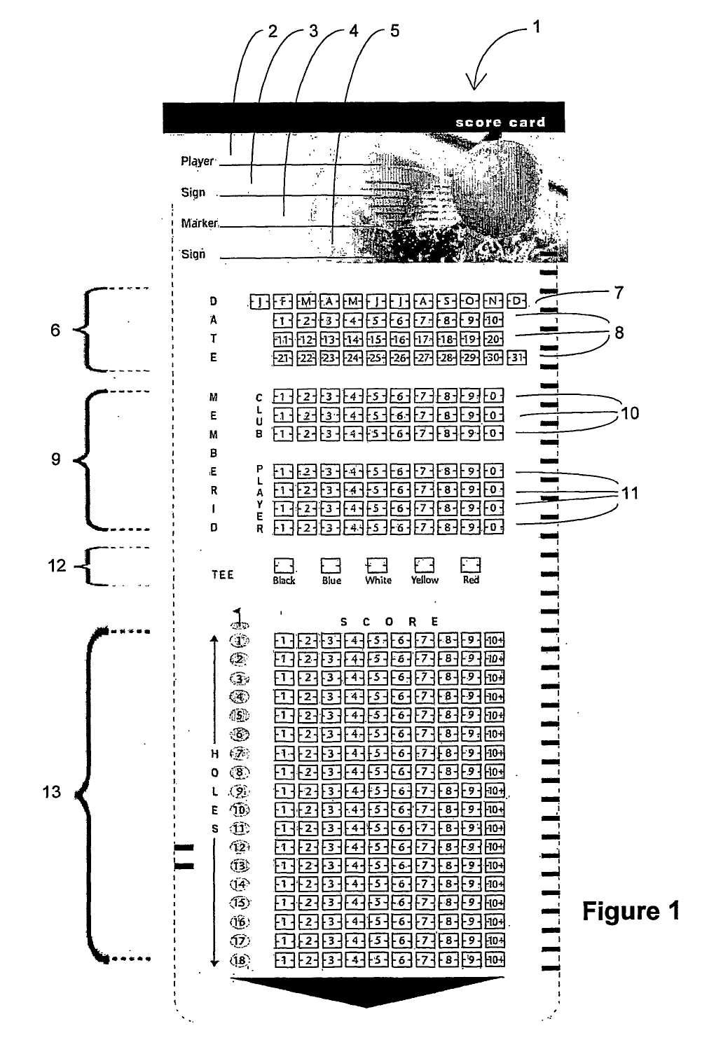

Referring to FIG. 1 data entry card 1 is seen to include region 2 for entering a player's name and region 3 for entering a player's signature. Region 4 is provided for entering a marker's name and region 5 for entering a marker's signature. Regions 2 to 5 are provided for the purpose of formal validation of a card and are not intended to be optically read.

A first region 6 includes a number of sub-regions defined as boxes for the entry of date information. Boxes in line 7 enable a month to be entered and boxes in row 8 enable a date to be entered. A player may use a suitable instrument, such as a pen, to mark the appropriate combination of boxes to enter the date.

Region 9 is for the entry of member identification information. Rows 10 enable a three digit club ID to be entered by marking a box containing the appropriate number from each horizontal row. Rows 11 enable a four digit player ID to be entered by marking an appropriate box in each row. In this manner a three digit club ID and four digit player ID may be entered. A single series of numbers (such as a single 3 digit code) could alternatively be used as the member identification. Row 12 enables a player to mark the box corresponding to the tees of which they played.

Region 13 is for the entry of scoring data. Each horizontal row has a series of boxes which may be marked according to the score for the corresponding hole. In this example boxes for the scores 1 to 9 and 10+ have been provided. In this case a single box is marked for each hole. Further boxes could be provided, if desired, or combinations of boxes could be utilised (e.g. the boxes 1, 2, 4, 8, 16, etc. could be provided and combinations marked to obtain the required score).

It will be seen that a player may enter a unique member ID, the date, tees played off and scores for each hole by marking appropriate boxes. This enables a standard card to be utilised for any course. The use of defined data boxes enables relatively inexpensive optical mark reading equipment to be utilised to process the card. Further, boxes may be provided for the entry of other information such as handicap etc.

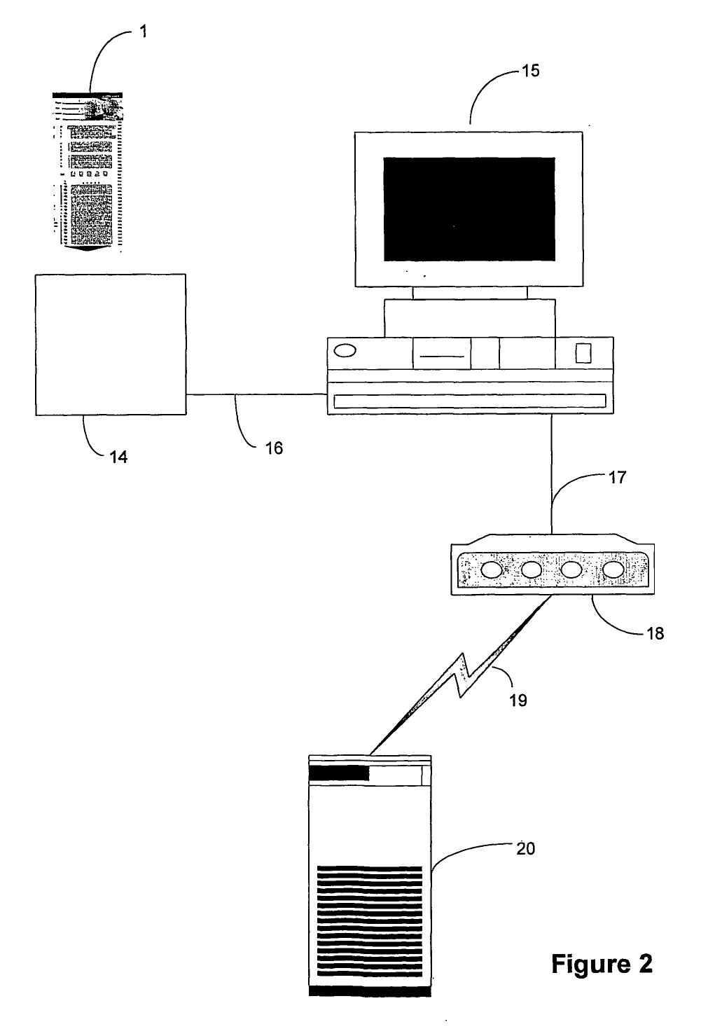

Referring now to FIG. 2 a system for processing the card shown in FIG. 1 is shown. Once information has been entered on data entry card it may be fed directly into an optical mark reader 14. A player could do this at the end of a round or deposit it in a box for later processing. Optical mark reader 14 may be a conventional mark reader such as the OMR-1100 optical mark reader produced by Chatsworth Data Corporation of the USA. This communicates with a processing means, such as computer 15, via an RS 232 serial communications interface 16. Data from optical mark reader 14 is supplied via serial link 16 to computer 15 and computer 15 may utilise the data to calculate handicapping information or tournament results directly. Alternatively, computer 15 may be connected via a serial or parallel link 17 to a modem 18 which communicates via a communications link 19 with remote processor 20. Remote processor 20 could be a centralised server which calculates handicapping information or tournament results on a national or regional basis.

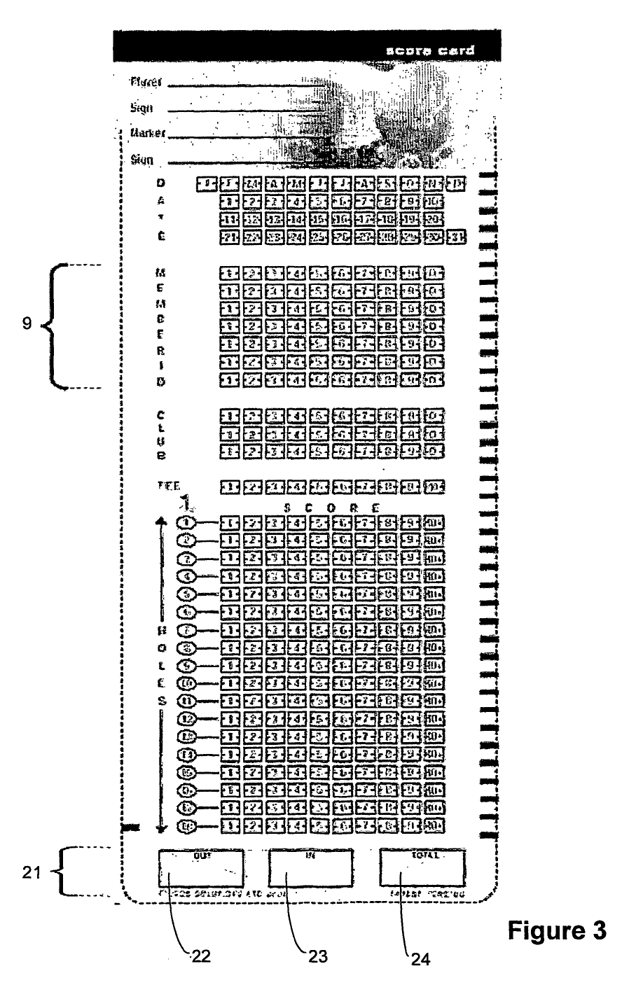

Referring now to FIG. 3 an alternative golf data entry card format is shown. In this case the member ID section 9 is in a single block and a player enters a single seven digit identification number. This approach may be suitable where nationwide or international member identification systems are to be employed.

The card shown in FIG. 3 also includes a region 21 for a player to record a score for the first 9 holes in box 22, a score for the last 9 holes in box 23 and a total score for the round in box 24.

The data entry card will typically be used in combination with a conventional scorecard. This enables a standard data entry card to be used for a large number of users and reduces costs.

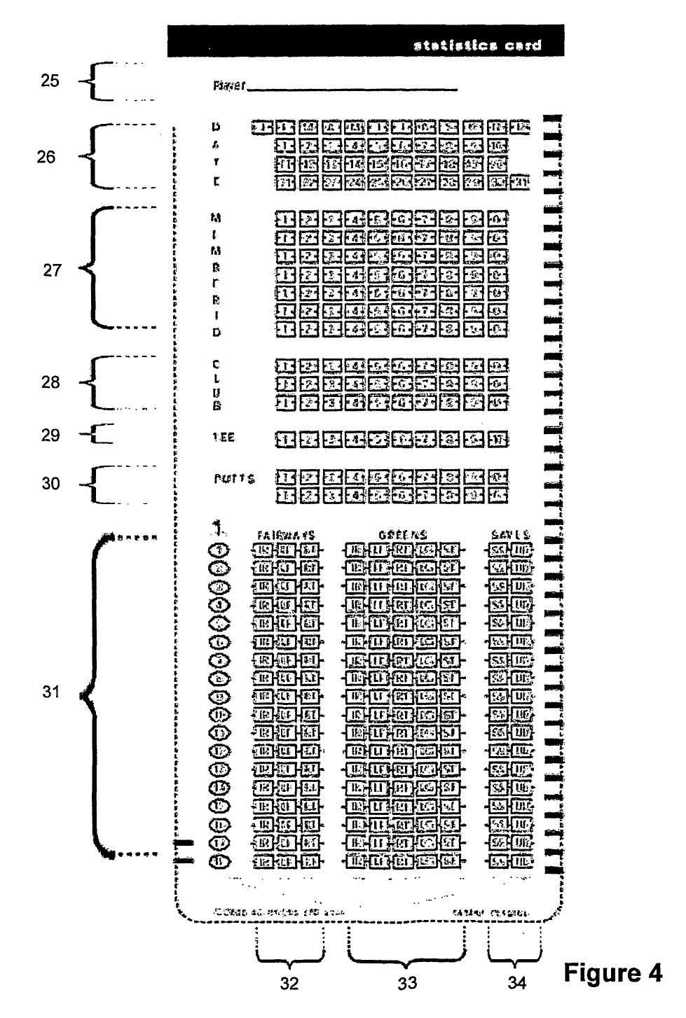

Referring now to FIG. 4 a golf statistics data entry card is shown. Statistical information recorded by a player can be analysed by a golf statistics software application to reveal patterns of play. Where information is gathered for a number of rounds a historical database may be developed which enables the strengths and weaknesses of a player to be analysed and highlighted. This information may be utilised to improve player skills.

As with the golf data entry card a player may enter their name in space 25, the date in region 26, the player membership ID in region 27, the club in region 28 and the tees used in region 29. The remainder of the card includes fields for entering statistical information.

In this case region 30 is provided for recording the total number of putts taken by a player during a round. In this example up to 99 putts may be recorded, although this could be adapted to accommodate any required number. Further, the number of putting strokes for each hole could be recorded if a region such as region 13 shown in FIG. 1 were provided.

Region 31 enables information regarding 10 key statistics to be recorded on a hole by hole basis. Region 32 enables information to be recorded regarding shots from the tee. The shot may be recorded as either in regulation “IR”, left “LF” or right “RT”.

Region 33 records approach shots. These are recorded as either in regulation “IR”, left “LF”, right “RT”, long “LG” or short “ST”.

Region 34 enables stroke savers to be recorded. Stroke savers occur where the green is not hit in regulation but the player holes out with one putt or less. Sand saves “SS” or up and downs “UD” may be recorded.

The statistics card may be processed by the optical card reader 14 in the same manner as the golf data entry card. The information from mark reader 14 is transferred to computer 15 and analysed. The number of putts may be divided by the number of holes played to determine the average number of putts per hole. All information may be statistically analysed by a computer 15 for a single round or on a historical basis to produce key statistics. The calculated statistical information may be displayed to a user in numerical graphical form.

It will thus be seen that the present invention provides a simple data entry card of a standard format that may be utilised by any participating course. The data entry card enables member ID information to be input in a format that can be read by an optical mark reader. The system for processing the data entry card is simple, accurate and reliable, and utilises standard low cost components.

Where in the foregoing description reference has been made to integers or components having known equivalents then such equivalents are herein incorporated as if individually set forth.

Although this invention has been described by way of example it is to be appreciated that improvements and/or modifications may be made thereto without departing from the scope of the invention as defined in the appended claims.

1. A golf data entry card including:
a first printed region including a plurality of sub-regions in a predetermined configuration suitable for reading by an optical mark reader having indicia printed therein for entering a member identification code; and
a second printed region including a plurality of sub-regions in a predetermined configuration suitable for reading by an optical mark reader having indicia for entering the number of strokes for each hole played.

2. A card as claimed in claim 1 wherein the indicia printed in the sub regions of the first printed region are numerals.

3. A card as claimed in claim 1 or claim 2 wherein the sub regions of the first printed region consist of a plurality of rows of boxes.

4. A card as claimed in claim 3 wherein the numerals 0 to 9 are printed in each row of boxes in the first printed region.

5. A card as claimed in claim 1 wherein the member identification code is in the form of a first series of boxes for entry of a club ID and a second series of boxes for entering a player ID.

6. A card as claimed in any preceding claim including a region for entering date information.

7. A card as claimed in any preceding claim including a region for entering information regarding tees played from.

8. A card as claimed in any preceding claim wherein the second printed region includes a row of boxes next to the number of each hole for entering a player's score for each hole.

9. A card as claimed in claim 8 wherein each row of boxes includes the numerals 1 to 9.

10. A card as claimed in any one of the preceding claims wherein boxes are provided for entry of players scores for the first 9 holes played, the last 9 holes played and the total for all holes played.

11. A card as claimed in any one of the preceding claims wherein regions are provided for entry of player and marker names and signatures.

12. A method of recording golf scoring information including the steps of:
i) providing a card as claimed in any one of the preceding claims;
ii) marking sub-regions of the first region to enter a member identification code;
iii) marking sub-regions of the second region to enter the number of strokes for the holes played;
iv) reading the card by an optical mark reader and providing the information to a processor; and
v) processing the information to generate scoring I information for the player.

13. A method as claimed in claim 12 wherein the processing means calculates a player's handicap on the basis of the scoring information.

14. A method as claimed in claim 12 wherein the processing means calculates a player's handicap on the basis of the scoring information and historical handicap information held by the processor.

15. A method as claimed in claim 12 wherein the processing means transmits the scoring information to a central processor.

16. A method as claimed in claim 15 wherein the central processor calculates a player's handicap based on the scoring information and historical scoring information.

17. A system for processing golf data entry cards including:
i) an optical mark reader suitable for reading a golf data entry card as claimed in any one of claims 1 to 11; and
ii) a processing means having a data connection to the optical mark reader programmed to extract information from the data entry card.

18. A system as claimed in claim 17 wherein the processing means includes means for calculating player handicap information.

19. A system as claimed in claim 17 including a central processor connected via a data link which receives data from the processing means and centrally stores player information and/or calculates handicap information.

20. A golf statistics data entry card including:
a first printed region including a plurality of sub regions in a predetermined configuration suitable for reading by an optical mark reader having indicia printed therein for entering a member identification code; and
a second printed region including a plurality of sub regions in a predetermined configuration suitable for reading by an optical mark reader having indicia relating to player statistical information printed in the sub regions.

21. A card as claimed in claim 20 wherein the second printed region includes a sub region for entering the number of putts for each hole.

22. A card as claimed in claim 20 or claim 21 wherein the second printed region includes a sub region for entering the number of putts for a round.

23. A card as claimed in any one of claims 20 to 22 wherein the second printed region includes a sub region for entering the direction of each drive.

24. A card as claimed in any one of claims 20 to 23 wherein the second printed region includes a sub region for entering the position of each approach shot with respect to the green.

25. A card as claimed in any one of claims 20 to 24 wherein the second printed region includes a sub region for entering stroke saving shots played on any hole.

26. A method of obtaining golf statistics information including the steps of:
i) providing a card as claimed in any one of claims 20 to 25;
ii) marking sub regions of the first region to enter a member identification code;
iii) marking sub regions of the second region to enter player statistical information;
iv) reading the card by an optical mark reader and providing information to a processor; and
v) processing the information to generate golf statistical information for the player.

27. A method as claimed in claim 26 wherein the information is processed in combination with historical statistical information to generate golf statistical information.

28. A golf data entry card substantially as herein described with reference to FIG. 1 or FIG. 3 of the accompanying drawings.

29. A golf statistics data entry card substantially as herein described with reference to FIG. 4 of the accompanying drawings.

30. A system for processing golf data entry cards substantially as herein described with reference to FIG. 2 of the accompanying drawings.

31. A method as claimed in claim 12 substantially as herein described.

32. A method as claimed in claim 26 substantially as herein described.
